(19) United States
(12) Patent Application Publication
(10) Pub. No.: US 2006/0104685 A1
(43) Pub. Date: May 18, 2006

(54) Printer and supply unit for the printer

(75) Inventors: Lodewijk T. Holtman, Venlo (NL); Hendrikus J.J. Van Soest, Helden (NL); Franciscus J.W.M. Wolters, Nijmegen (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V.

(21) Appl. No.: 11/269,565

(22) Filed: Nov. 9, 2005

(30) Foreign Application Priority Data
Nov. 12, 2004 (NL) 1027494

(51) Int. Cl. G03G 15/00

(52) U.S. Cl. 399/384

(57) ABSTRACT

A printer for printing a substrate, including a print unit and a supply unit for holding a substrate and delivering the substrate for transport to the print unit, wherein the supply unit is provided with a member for receiving a core on which the substrate is wound, whereby the member containing the core is functionally connected to a motor for rotatably driving the core, and a downstream transport nip for engaging and transporting an unwound part of the substrate, said transport nip for the driving thereof being functionally connected to the said motor, wherein the transmission from the motor to the core and the nip, respectively, is such that on transport of the substrate to the print unit only the nip is actively driven by the motor and on the return of the substrate for winding thereof on the core both the core and the nip are actively driven by the motor, the core winding up as many meters of substrate per second as the nip returns.

### BACKGROUND OF THE INVENTION

The present invention relates to a printer for printing a substrate, including a print unit and a supply unit for holding a substrate and delivering the substrate for transport to the print unit, wherein the supply unit is provided with a member for receiving a core on which the substrate is wound, whereby after reception by the member said core is functionally connected to a motor for rotatably driving the core, and a downstream transport nip for engaging and transporting an unwound part of the substrate. The transport nip is functionally connected to the motor for the purpose of being driven thereby.

In a printer of this kind, the transport of the substrate must, under all conditions, be very accurate, particularly when the printer builds up an image on the substrate from a set of sub-images which must adjoin one another accurately. However, it is often also necessary to wind the substrate back on the core, for example because a different substrate has to be printed or because the core with the substrate wound thereon must itself be completely replaced by a new type of substrate. In the above-mentioned printer the return movement of the substrate is often found to be accompanied by inaccuracies in the winding of the substrate on the core, and there also appears to be regular damage to the substrate, such as folds and the like. These inaccuracies and damage have a negative effect on the print quality when the substrate has to be unwound again from the core for printing.

### SUMMARY OF THE INVENTION

The object of the present invention is to provide a printer with a drive for the core and transport nip which is inexpensive but nevertheless provides accurate transport of the substrate to the print unit and, if necessary, accurate winding of the substrate on the core. To this end, a printer has been invented whereby the transmission from the motor to the core and the nip, respectively, is such that on transport of the substrate to the print unit only the nip is actively driven by the motor and on the return of the substrate for winding thereof on the core both the core and the nip are actively driven by the motor, the core winding up as many meters of substrate per second as the nip returns.

In the present printer, during the unwinding of the substrate, only the nip is actively driven by the motor. The speed of transport of the substrate is thus determined by the speed that the nip imposes on the substrate. Since the substrate is still situated on the core upstream (considered in the direction of transport of said substrate), a pull is exerted on the substrate automatically during transport, the substrate being unwound from the core during this process. The core is not actively driven in these conditions by the motor but rotates freely. An accurate unwinding of the substrate can take place in this manner. During winding it has been found advantageous to drive both the core and the nip actively. A torque is transferred to both components of the printer by means of the motor. This prevents any slack from forming in the substrate by making the speed of winding on to the core equal to the speed of transport of the nip. It has been found that this can result in a very accurate winding of the substrate on the core, with practically no damage occurring to the substrate. Thus the wound substrate can be re-used in a printer for the printing thereof.

In one embodiment, the transmission comprises a freewheel bearing between the motor and the core such that during the transport of the substrate to the print unit the core is decoupled from the motor. The use of a freewheel bearing is a simple and reliable means of providing a break in the active drive between the motor and the core. The bearing is so mounted that practically no power from the motor is transmitted to the core during the unwinding of the substrate. On winding up, however, the bearing itself provides a direct coupling between the motor and the core.

In one embodiment, the ratio in the transmission from the motor to the core and the nip, respectively, on the return movement is such that if the nip and the core rotate freely the speed at which the substrate is wound on the core in meters of substrate per second is at all times greater than the speed that the nip imparts to the substrate. This embodiment provides for the core to tend to impose on the substrate always a higher speed than the nip, in principle, during the return movement of the substrate. In this way it is made certain that there is no slack in the substrate between the nip and the core during the return movement of the substrate. In a further embodiment, a slipping clutch is provided between the motor and the core to ensure that the actual speed of winding, i.e., the winding speed when the substrate is on the core and is engaged by its free end by the nip, is equal to the speed that the nip imposes on the substrate during the return movement. This embodiment has the advantage that no slip is imposed in the nip. The speed of the return movement is determined by the nip. The slipping clutch ensures that the transmission from the motor to the core is at least decoupled for a percentage, in fact such that the speed of winding of the substrate on the core is exactly equal to the speed of transport of the nip.

In one embodiment, a braking torque that counteracts rotation of the core is provided at least during the unwinding of the substrate. Using this braking torque can prevent the core—which may have a relatively high inertia due to the possible presence of a large amount of substrate—from still rotating for some time when the nip is no longer actively driven by the motor. If the core were in fact to continue to rotate for some time before completely stopping, then a slack of the substrate would be formed between the core and the nip, and this is disadvantageous for the further transport of the substrate if the nip is again driven. In a further embodiment, a braking torque is continuously applied to the core, for example by keeping a mechanical brake shoe pressed against the peripheral edge of the core. The advantage of this embodiment is that the continued rotation of the core can be counteracted under all circumstances.

In one embodiment, a second nip is provided downstream of the transport nip for engaging and transporting the substrate to the print surface. The second nip is provided with its own drive motor. It has been found that the transport of the substrate can, as a result, be even more accurate. In a further embodiment, the drive of the first transport nip is switched off if the substrate is engaged by the second nip. In this embodiment, the second transport nip therefore determines the speed of transport of the substrate to the print unit. In this embodiment, the first nip co-rotates since the substrate is also engaged by this nip. In yet another embodiment, the motor for driving the first transport nip is an electric motor which during the said switching-off does not form part of a closed electric circuit. This can be effected, for example, by electrically decoupling the terminals of the electric motor from the motor by the use of a switch. In this way it is possible to prevent the motor from acting as an electromechanical brake for the first nip during the co-rotation thereof.

In one embodiment, the speed of the substrate in meters per second during the return to the core is determined by the speed imposed on the substrate by the second nip. In this embodiment, at least as long as the substrate is engaged by both the first and second nip during the return movement to the core, the speed of the return movement is equal to the speed of transport of the second nip. The first nip is then, for example, decoupled from its drive by the use of a unidirectional bearing. However, as soon as the substrate leaves the second nip the speed of the return movement will again be determined by the first nip as indicated previously. The present invention also relates to a supply unit for a printer, particularly an inkjet printer.

### BRIEF DESCRIPTION OF DRAWINGS

The present invention will now be explained with reference to the following drawings, wherein,

FIG. 1 is a diagram showing a printer according to the present invention;

FIG. 2 is a diagram showing a drawer of a supply unit for the printer;

FIG. 3 is a diagram showing some of the components which ensure substrate transport; and

FIG. 4 is a diagram showing the transmissions between the drive motors and the core and transport nips, respectively.

### DETAILED DESCRIPTION OF THE INVENTION

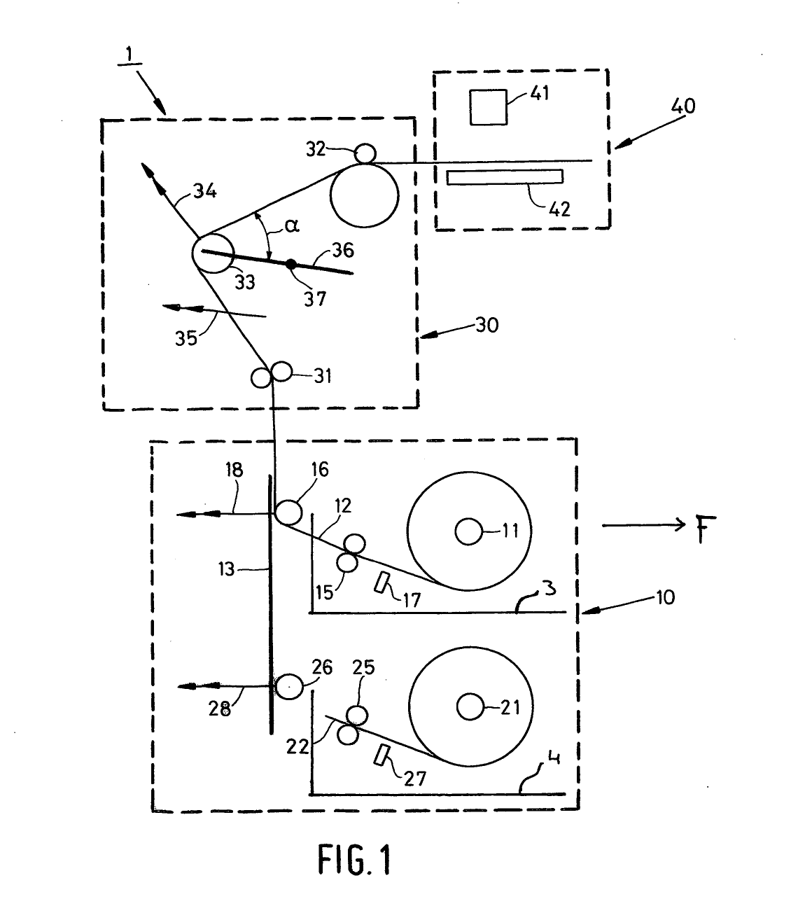

FIG. 1 is a diagram showing a printer according to the present invention. The printer is provided with a supply unit 10 which serves for storage and delivery of the substrate for printing. In addition, the printer includes transport unit 30 which transports the substrate from the supply unit 10 to the print unit 40. Unit 30 also ensures accurate positioning of the substrate in the print zone formed between the print surface 42 and the inkjet printhead 41. In this embodiment, print unit 40 is a conventional engine containing printhead 41 which is constructed from a number of loose sub-heads, one for each of the colors black, cyan, magenta and yellow. A printhead of this type is described in detail in European patent application EP 1 378 360. Printhead 41 has only a limited print range so that it is necessary to print the image on the substrate in various sub-images. For this purpose, the substrate is transported incrementally in each case in the transit direction (subscan direction) so that a new part of the substrate can be printed in the print zone. In the example illustrated, the substrate 12 originates from core 11 containing a roll of substrate, which roll is situated in the supply unit 10. The roll is received in drawer 3 of the supply unit. A web of substrate is wound on the core 11 of the roll and has a length of 200 meters. To accommodate the roll in the printer the drawer 3 is provided with a holder (not shown) to support the core. As a result the roll can be rotatably accommodated in the drawer. The holder has two support members received in side plates of the drawer, the members being brought into cooperative connection with the ends of the roll. In this embodiment the supply unit is provided with a second drawer 4 to receive an additional, subsequent roll having a core 21 on which the substrate 22 is wound. This substrate 22 can also be delivered by the supply unit for printing. The drawers can be pushed out of the supply unit 10 in the indicated direction F for the withdrawal of the rolls and/or insertion of new rolls. For the transport of the substrate, core 11 is operatively connected to transport elements 15, which, in this case, is a pair of rollers between which a transport nip is formed. A sensor 17 is mounted upstream of means 15 to determine whether there is still substrate on the roll in the relevant holder. The holder is also provided with transport elements 25 for the transport of a substrate originating from the other roll. Upstream of the transport elements the supply holder is provided with sensor 27 which has the same function as sensor 17. The supply holder is provided with guide elements 16 and 26 to guide the substrates 12 and 22 respectively to the transport unit 30. Transit path 13 is located downstream of these guide elements. This transit path is used for both the transport of substrate 12 and the transport of substrate 22.

The substrate leaving the supply unit 10, e.g., substrate 12 in this example, is engaged by transport elements 31 of the transport unit 30. Those transport elements transport the substrate via guide element 33 onto second transport elements 32 of the transport unit 30. The transport means 32 engages the substrate and transports it on to the print unit 40. Thus the printer is configured to print substrate 12. For configuration to print substrate 22, it is necessary in this case to wind substrate 12 back on the core 11 so that the free end finally leaves the transit path 13. Roller pair 15 still holds the substrate 12 fast. Substrate 22 can then be spooled over guide element 26 by the drive of the roller pair 25 until nip 31 is reached whereupon the latter takes over the drive for the substrate and spools the substrate onto nip 32 for conveyance to the print surface 42. The printer is then configured to print substrate 22.

The guide elements 16 and 26 are, in this example, rollers extending parallel to the transport means 15 and 31; 25 and 31, respectively. They are basically stationary rollers (i.e., they cannot rotate about their axial axis). The guide elements are so disposed in the supply unit that they can each rotate, at least through a limited angle, about an axis. In the drawing, the rotational axis 18 of element 16 is shown and also rotational axis 28 of element 26. These rotational axes are perpendicular to the axes of the guide elements and intersect the middle of these elements.

Guide element 33 of transport unit 30, which element extends substantially parallel to the transport means 31 and 32, is also so disposed that it can rotate about an axis perpendicular to the axial direction of the said element. Said axis is shown by reference 34 and intersects the middle of guide element 33. Since element 33 in this embodiment is a co-rotating roller, the substrate remains substantially stationary with respect to the surface of this guide element. Element 33 is also so suspended so that it can rotate about axis 35, which axis 35 extends parallel to the bisector 36 of the angle 2α over which the substrate is fed from means 31 to means 32. The axis 35 intersects the middle of the substrate web at a distance of about 1 meter from the guide element itself.

Guide element 33 is movable from a first position in which said element is situated in FIG. 1, to a second position in which the center of this element coincides with location 37. In the first position, the distance over which substrate 12 extends between transport means 31 and transport means 32 is a maximum. In the second position this distance is a minimum. Use is made of this during the transport of the substrate to print unit 40. Since the substrate must in each case be moved over a relatively small distance (typically 5 to 10 cm), it is advantageous for this to take place relatively rapidly. However, the mass inertia of roll 11, certainly when it is provided with the maximum quantity of substrate, is relatively high. For that reason, displacement while maintaining the configuration shown for transport elements and guide elements would take, relatively, a considerable amount of time. To counteract this problem, transport means 31 is accelerated much more slowly than transport means 32. However, in order to ensure sufficient supply of substrate to the transport means 32, the guide element 33 is moved in the direction of location 37.

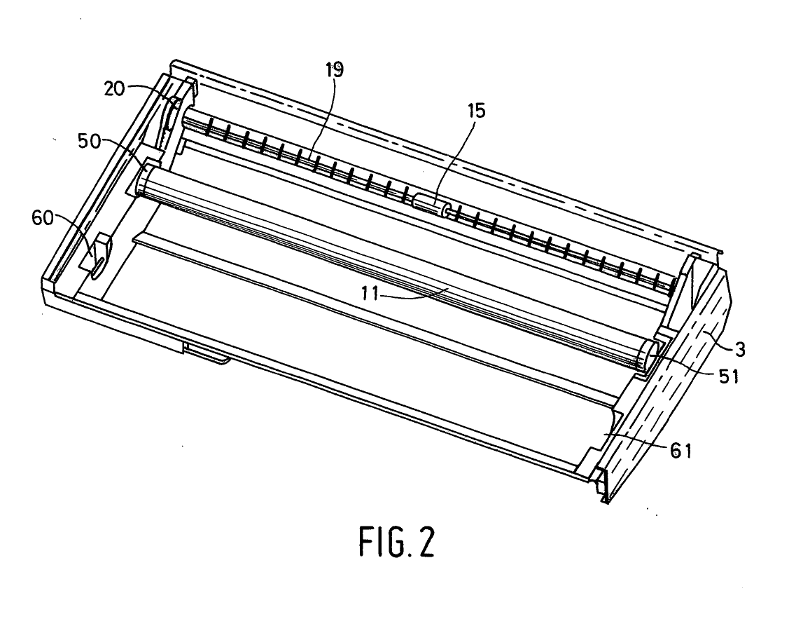

FIG. 2 diagrammatically illustrates an alternative embodiment of the drawer 3. In this case, the drawer is provided with two holders to receive two individual cores. The first holder comprises a first pair of support members 50 and 51. The second holder comprises a second pair of support members 60 and 61. In the drawing, the core 11 is received in the first holder. When this drawer is in use in a printer the core present therein will be provided with a substrate wound thereon (not shown). To unwind the substrate, the core is rotatably accommodated in the holder. Roller pair 15, of which only one roller is visible in the drawing, also forms part of the drawer. The roller illustrated is mounted on shaft 19 which can be driven by gearwheel 20.

The distance between the support members is such that a user can readily place a roll in the holder by substantially making the ends of the core coincide with the positions of the two support members. After the roll has been placed in the holder, it is automatically brought by a number of resilient elements (not shown) into a substantially fixed position with respect to the print surface.

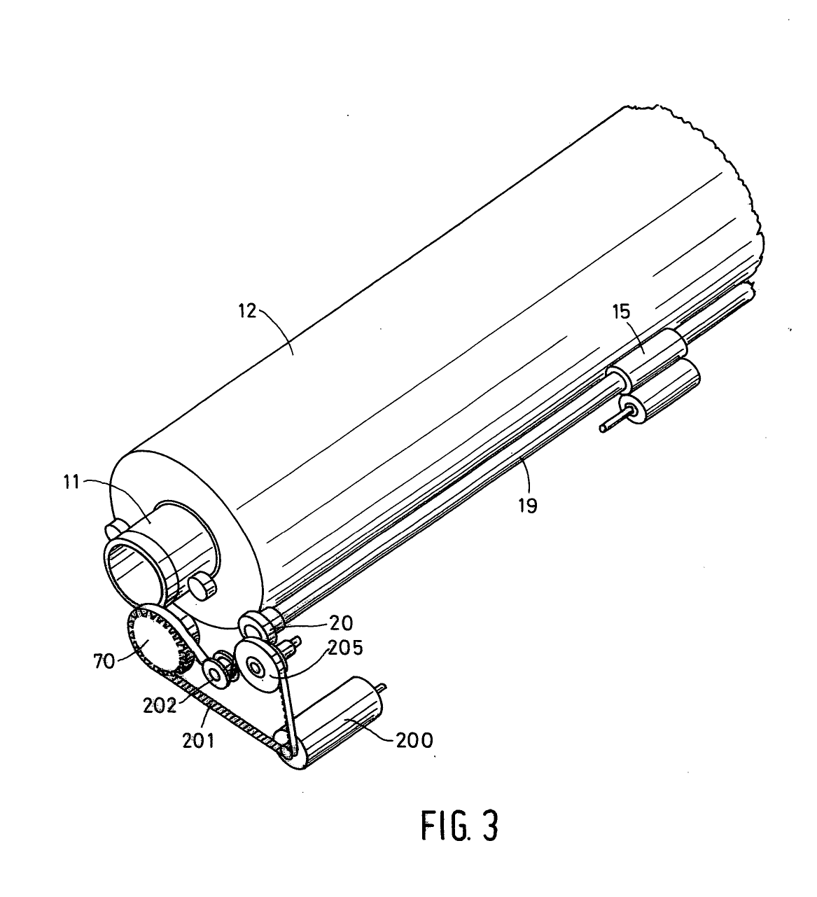

FIG. 3 diagrammatically shows a number of components of the supply unit ensuring transport of a substrate from a roll to the print surface. For clarification, only those parts corresponding to one roll are shown. In the supply unit according to this embodiment, the drawer in which the roll is situated also comprises a second holder (not shown) suitable for receiving a roll of substrate. This second holder has the same components as shown in the drawing.

The roll illustrated includes substrate 12 rolled on core 11. An electric motor 200 is provided which is operatively connected via a drive belt 201 to gearwheel 70 and wheel 205. Belt 201 is trained over tensioning element 202. When the electric motor is switched on a driving force is transmitted to the wheels 70 and 205. It is thus possible to drive the core 11 of the roll, which consists of said core and the substrate 12 wound thereon, and also wheel 20 connected to shaft 19 on which one roller of roller pair 15 is mounted. To transport the substrate 12 to print surface 42 (not shown) the free end of the substrate must be brought into the transport nip formed by roller pair 15, after which said roller pair is driven via a shaft 19. During transport through this nip to the print surface, no power from the electric motor is transmitted to the core since a unidirectional bearing (not shown) is used. When the substrate is spooled back to the core and rewound thereon, the core 11 and shaft 19 are driven. By means of a slipping clutch (not shown) between the core 11 and the electric motor 200, the winding speed at the roll is made equal to the speed of feed of the substrate at the roller pair 15.

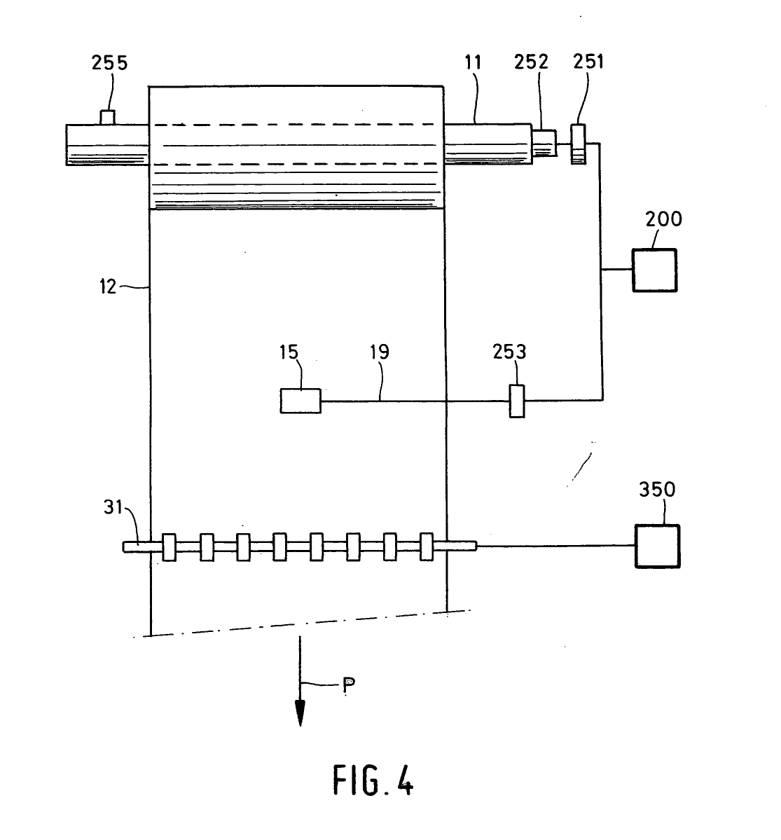

FIG. 4 is a diagram showing the transmissions between the drive motors 200 and 350 and the core 11, and the transport nips 15 and 31 respectively. In the example illustrated, core 11, on which part of the substrate 12 is wound, is operatively connected to electric motor 200. The first transport nip 15 is also operatively connected to this motor 200. Between the motor 200 and the core there is provided a unidirectional bearing 251, and a slipping clutch 252. The unidirectional bearing ensures that the core 11 is not actively driven by the motor 200 when the free end of the substrate 12 is transported in the indicated direction P with the nip 15 being driven. Although internal friction in the bearing may mean that small forces are still transmitted from the motor 200 to the core 11 in this situation, they are such that they cannot cause any more rapid unwinding of the substrate 12 from the core 11 than the speed at which the nip 15 transports the substrate 12 in the direction P. The slipping clutch ensures that during the winding of the substrate 12 on the core 11 the speed of winding is determined by the speed that the transport nip 15 imposes on the substrate 12. The outside diameter of the core and the transmission from the motor 200 to this core are such that the slipping clutch will, in all circumstances, slip during the return winding of the substrate. In this embodiment, a felt brake shoe 255 is pressed against the core and provides a continuous braking torque on the core. In this way the core is prevented from continuing to rotate when the drive is switched off.

The second transport nip 31 is connected to drive motor 350. During the transport of the substrate 12 in the indicated direction P the speed of transport is imposed by the nip 31. Nip 15 and core 11 are then not driven but rotate freely because tension is exerted on the substrate 12. During the return movement of the substrate the two motors are driven. In the situation illustrated, however, in which the substrate is located both in the nip 15 and in the nip 31, the coupling between nip 15 and motor 200 is interrupted by the use of a unidirectional bearing 253. In this way the nip 31 determines what is the speed of the return movement. The winding speed at the core using the slipping clutch is such that it is exactly equal to the speed of transport at the nip 31. As soon as the substrate leaves nip 31, coupling takes place between the motor 200 and the nip 15 so that the latter is again actively driven. Further winding takes place as indicated above.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A printer for printing a substrate which comprises
a print unit and a supply unit for holding a substrate and delivering said substrate for transport to the print unit, the supply unit being provided with a member for receiving a core on which the substrate is wound whereby the member containing the core is functionally connected to a motor for rotatably driving the core, and
a downstream transport nip for engaging and transporting an unwound part of the substrate, said transport nip for the driving thereof being functionally connected to the said motor, wherein the transmission from the motor to the core and the nip, respectively, is such that:
on transport of the substrate to the print unit only the nip is actively driven by the motor and
on the return of the substrate for winding thereof on the core both the core and the nip are actively driven by the motor, the core winding up as many meters of substrate per second as the nip returns.

2. The printer according to claim 1, wherein the transmission includes a freewheel bearing between the motor and the core such that during the transport of the substrate to the print unit the core is decoupled from the motor.

3. The printer according to claim 1, wherein the ratio in the transmission from the motor to the core and the nip, respectively, on the return movement is such that if the nip and the core rotate freely, the speed at which the substrate is wound on the core in meters of substrate per second is at all times greater than the speed that the nip imparts to the substrate.

4. The printer according to claim 3, wherein a slipping clutch is provided between the motor and the core in order to ensure that the actual winding speed is equal to the speed that the nip imposes on the substrate during the return movement.

5. The printer according to claim 1, wherein a braking torque that counteracts rotation of the core is provided at least during the unwinding of the substrate.

6. The printer according to claim 5, wherein the braking torque is continuously applied to the core.

7. The printer according to claim 1, wherein a second nip is provided downstream of the transport nip for engaging and transporting the substrate to the print surface, said second nip being provided with its own drive motor.

8. The printer according to claim 7, wherein the drive of the first transport nip is switched off if the substrate is engaged by the second nip.

9. The printer according to claim 8, wherein the motor for driving the first transport nip is an electric motor which, during the said switching-off, does not form part of a closed electric circuit.

10. The printer according to claim 7, wherein the speed of the substrate in meters per second during the return to the core is determined by the speed imposed on the substrate by the second nip.

11. A supply unit for a printer which is adapted to hold a substrate and deliver the substrate for transport to a print unit of the printer, wherein the supply unit is provided with a member for receiving a core on which the substrate is wound whereby the member containing the core is functionally connected to a motor for rotatably driving the core, and a downstream transport nip for engaging and transporting an unwound part of the substrate, said transport nip for the drive thereof being functionally connected to the said motor, wherein the transmission from the motor to the core and the nip, respectively, is such that:
on transport of the substrate to the print unit only the nip is actively driven by the motor and
on the return of the substrate for winding thereof on the core both the core and the nip are actively driven by the motor, the core winding up as many meters of substrate per second as the nip returns.
